(19) United States
(12) Patent Application Publication
(10) Pub. No.: US 2008/0060199 A1
(43) Pub. Date: Mar. 13, 2008

(54) Method of manufacturing a manifold

(76) Inventors: Christopher Alfred Fuller, East Aurora, NY (US); Henry Earl Beamer, Middleport, NY (US)

Correspondence Address: DELPHI TECHNOLOGIES, INC., M/C 480-410-202, PO BOX 5052, TROY, MI, 48007, US

(21) Appl. No.: 11/492,525

(22) Filed: Jul. 25, 2006

(51) Int. Cl. B23P 15/26

(52) U.S. Cl. 29/890.052

(57) ABSTRACT

A method of manufacturing a manifold of a heat exchanger is provided. The manifold has an outer wall and an inner tube with a cavity formed there between. The method utilizes a punch having a first cusp and a second cusp and includes the step of lancing the outer wall of the manifold utilizing both the first and second cusps to form a first aperture in the outer wall and to dispose the first and second cusps in the cavity. The method also includes the steps of moving the first and second cusps through the cavity toward the inner tube while maintaining at least one of the first and second cusps within the cavity and lancing the inner tube of the manifold utilizing the second cusp to form a second aperture in the inner tube. The method still further includes the step of retracting the punch from the manifold.

### BACKGROUND OF THE INVENTION

1. Field of the Invention

The present invention generally relates to a method of manufacturing a manifold. More specifically, the present invention relates to a method of manufacturing a manifold for a heat exchanger utilizing a punch.

2. Description of the Related Art

Brazed heat exchangers are beginning to find application in residential air conditioning and heat pump applications due to superior heat transfer performance. Typically, the brazed heat exchangers include two manifolds, one of which is shown in FIG. 1 generally at 1. The heat exchangers also typically include a series of flow tubes extending between the two manifolds 1. The heat exchangers can function as condensers in a cooling mode and as evaporators in a heating mode. In each of the cooling and heating modes, a refrigerant is pumped into the manifolds 1. However, velocity and distribution of the refrigerant in each of the cooling and heating modes vary. In the heating mode, the refrigerant is pumped through the manifolds 1 and through the flow tubes to absorb heat from air passing over the flow tubes. As the refrigerant absorbs heat from the air, the refrigerant expands as liquid refrigerant is converted to gaseous refrigerant. A large difference in density between the liquid refrigerant and the gaseous refrigerant causes uneven refrigerant distribution in the flow tubes, thereby decreasing performance.

Various efforts have been made in manufacturing manifolds 1 to overcome the decreased performance due to the uneven distribution of the refrigerant. One method includes manufacturing manifolds 1 including distributor tubes 2, which are also known as inner tubes, which distribute the refrigerant throughout the manifolds 1, as also shown in FIG. 1. In this method, apertures are formed in both an outer wall 3 of the manifold 1 and in the inner tube 2 to facilitate the distribution of the refrigerant. It is believed that improving the distribution of the refrigerant maximizes performance of the heat exchanger.

Specifically, in one version of this method, two punches are utilized to form the apertures in the outer wall 3 of the manifold 1 and in the inner tube 2, which are integrally connected. Initially, a first punch 4 is used to form the aperture in the outer wall 3 of the manifold 1 and is then retracted from the manifold 1. Subsequently, a second punch, not shown, is passed through the aperture in the outer wall 3 of the manifold 1 and used to form the aperture in the inner tube 2. After forming the aperture in the inner tube 2, the second punch is retracted from the manifold 1.

In another version of this method, the same two punches are utilized. However, in this version, the outer wall 3 of the manifold 1 and the inner tube 2 are not integrally connected and are two distinct pieces. As such, the first punch 4 is used to form the aperture in the outer wall 3 of the manifold 1. Then, the second punch is used to form the aperture in the inner tube 2. Finally, the inner tube 2 is inserted into and oriented in the manifold 1 during assembly to align the apertures in the outer wall 3 and in the inner tube 2. This adds an additional production step to the method.

Although both versions of this method are very effective in forming the apertures in both the outer wall 3 and the inner tube 2, the method requires two separate punches and at least two distinct steps, which increase production costs and complexities and manufacturing times. Also, moving the second punch through the aperture formed in the outer wall 3 increases a potential for damaging the aperture in the outer wall 3. Accordingly, there remains an opportunity to manufacture a manifold utilizing a single punch that can form the aperture in both the outer wall of the manifold and the inner tube while reducing production costs and complexities and manufacturing times.

### SUMMARY OF THE INVENTION AND ADVANTAGES

The present invention provides a method of manufacturing a manifold of a heat exchanger. The manifold has an outer wall and an inner tube with a cavity formed between the outer wall and the inner tube. The method utilizes a punch having a first cusp and a second cusp. The method also includes the step of lancing the outer wall of the manifold utilizing both the first and second cusps to form a first aperture in the outer wall of the manifold and to dispose the first and second cusps in the cavity. The method further includes the step of moving the first and second cusps through the cavity toward the inner tube while maintaining at least one of the first and second cusps within the cavity. The method still further includes the step of lancing the inner tube of the manifold utilizing the second cusp to form a second aperture in the inner tube. The method additionally includes the step of retracting the punch from the manifold.

The method of manufacturing the manifold forms the first aperture in the outer wall and the second aperture in the inner tube. The second aperture in the inner tube is formed to facilitate uniform distribution of a refrigerant throughout the heat exchanger. Improving distribution of the refrigerant maximizes performance of the heat exchanger. The method also utilizes a single punch and reduces production costs and complexities and manufacturing times of the manifold.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings wherein:

FIG. 1 is a cross-sectional end view of a prior art manifold in a steel die, wherein the prior art manifold has an aperture formed in an outer wall of the manifold from a first prior art punch;

FIG. 2 is a cross-sectional end view of a first embodiment of the present invention, wherein a second cusp is disposed in a center of a punch and the second cusp is engaging the outer wall of the manifold;

FIG. 2a is a top view of the punch of the first embodiment of the present invention as utilized in FIG. 2;

FIG. 3 is a cross-sectional end view of the first embodiment of the present invention, wherein the punch has a pair of first cusps and the second cusp, and the pair of first cusps and the second cusp have lanced the outer wall of the manifold;

FIG. 4 is a cross-sectional end view of the first embodiment of the present invention, wherein the pair of first cusps and the second cusp are moving in a cavity toward the inner tube;

FIG. 5 is a cross-sectional end view of the first embodiment of the present invention, wherein the second cusp has lanced the inner tube;

FIG. 6 is a cross-sectional end view of the first embodiment of the present invention, wherein the punch is retracting from the manifold;

FIG. 7 is a cross-sectional end view of a second embodiment of the present invention, wherein the inner tube has a variable thickness, the manifold is rotated to align the inner tube and the second cusp, and the second cusp has lanced the inner tube;

FIG. 7a is a top view of the punch of the second embodiment of the present invention as utilized in FIG. 7.

FIG. 8 is a cross-sectional end view of a second embodiment of the present invention, wherein the inner tube has a consistent thickness, the manifold is rotated to align the inner tube and the second cusp, and the second cusp has lanced the inner tube;

FIG. 8a is a top view of the punch of the second embodiment of the present invention as utilized in FIG. 8;

FIG. 9 is a cross-sectional end view of a third embodiment of the present invention, wherein the second cusp is offset from the center of the punch, the second cusp is movable, the manifold is rotated to align the inner tube and the second cusp, and the second cusp has lanced the inner tube;

FIG. 9a is a top view of the punch of the third embodiment of the present invention as utilized in FIG. 9;

FIG. 10 is a cross-sectional end view of a fourth embodiment of the present invention, wherein the first cusp and the second cusp have lanced the outer wall of the manifold and the inner tube and wherein the manifold and the inner tube are a single piece; and

FIG. 10a is a top view of the punch of the fourth embodiment of the present invention as utilized in FIG. 10.

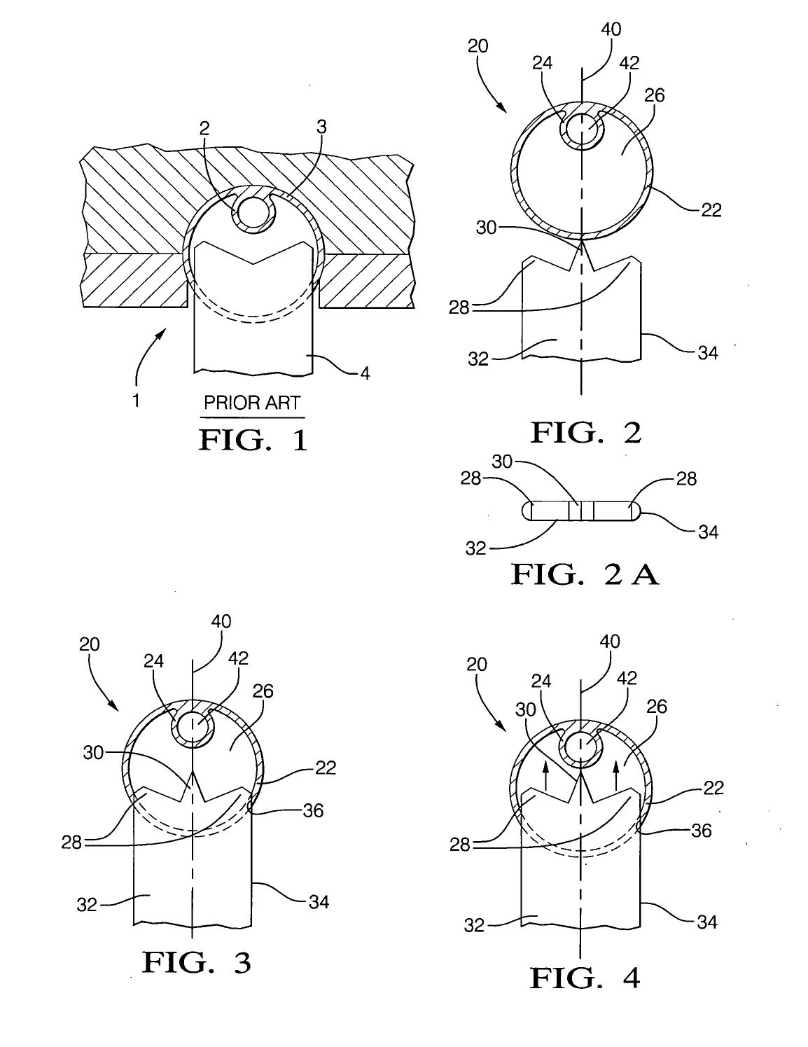

### DETAILED DESCRIPTION OF THE INVENTION

Referring to the Figures, wherein like numerals indicate like or corresponding parts through the several views, a manifold is shown in FIG. 2 generally at 20.

The present invention provides a method of manufacturing a manifold 20 for a heat exchanger. The manifold 20, as shown in FIGS. 2 through 10, may be any known in the art and may be formed from any material including, but not limited to, metals, composites, polymers, plastics, and combinations thereof. Preferably, the manifold 20 is formed from metal and is used in residential air conditioning and heat pump applications. The manifold 20 may also have any shape and size, as selected by one skilled in the art. In one embodiment, the manifold 20 is circular.

The manifold 20 has an outer wall 22 and an inner tube 24, also known as a distributor tube, as shown in FIGS. 2 through 10. The inner tube 24 distributes a refrigerant throughout the manifold 20 to minimize a phase separation of the refrigerant and maximize performance of the manifold 20. The outer wall 22 and the inner tube 24 may be formed integrally with each other or the inner tube 24 may be inserted into the manifold 20 separately from the outer wall 22. If inserted into the manifold 20, the inner tube 24 may require alignment within the manifold 20 in relation to the outer wall 22.

The outer wall 22 may have any thickness and any size. In one embodiment, the outer wall 22 has a thickness selected to provide sufficient burst strength. In another embodiment, the outer wall 22 has a thickness that is similar to a thickness of the inner tube 24.

The inner tube 24, like the manifold 20, may be formed from any material and is preferably formed from metal. The inner tube 24 may also have any thickness and any size and defines a chamber 42. In one embodiment, the inner tube 24 has a thickness that is less than the thickness of the outer wall 22 due to a relatively small pressure difference existing between the chamber 42 and a cavity 26 formed between the outer wall 22 and the inner tube 24, described in greater detail below. In another embodiment, as shown in FIG. 7, the inner tube 24 has a variable thickness to provide mechanical support during the method as well as a locally reduced thickness at a point of forming the second aperture 38 in the inner tube 24. The inner tube 24 may also have any shape and preferably is circular. However, in one embodiment, the inner tube 24 is D-shaped, as shown in FIG. 10.

Referring now to the cavity 26, first introduced above, the manifold 20 has the cavity 26 formed between the outer wall 22 and the inner tube 24, in addition to the chamber 42. The cavity 26 may be of any size and volume, and corresponds to the sizes of both the manifold 20 and the inner tube 24. Specifically, the size and volume of the cavity 26 are defined by the outer perimeter of the inner tube 24 and the inner perimeter of the outer wall 22.

The method utilizes a punch 32 having a first cusp 28 and a second cusp 30, as shown in FIGS. 2 through 10. As described in greater detail below, the punch 32 may have a variety of configurations, as shown in FIG. 2a and FIGS. 7a through 10a. In a first embodiment, the punch 32 has a pair of first cusps 28 and the second cusp 30. The pair of first cusps 28 may be disposed symmetrically about a center 40 of the punch 32. The punch 32 also preferably has opposing sides 34 in a parallel spaced relationship and the pair of first cusps 28 and second cusp 30 are preferably disposed interiorly to the sides 34. Alternatively, the first cusp 28 and second cusp 30 may be aligned with the sides 34 and not disposed interiorly to the sides 34.

In all embodiments, the method includes the step of lancing the outer wall 22 of the manifold 20 utilizing both the first and second cusps 28,30 to form a first aperture 36 in the outer wall 22 of the manifold 20 and to dispose the first and second cusps 28,30 in the cavity 26. The method also includes the step of moving the first and second cusps 28,30 through the cavity 26 toward the inner tube 24 while maintaining at least one of the first and second cusps 28,30 within the cavity 26. The method further includes the step of lancing the inner tube 24 of the manifold 20 utilizing the second cusp 30 to form a second aperture 38 in the inner tube 24. Still further, the method includes the step of retracting the punch 32 from the manifold 20.

Specifically, in an embodiment of FIGS. 2 through 6, the second cusp 30 is disposed in the center 40 of the punch 32 between the pair of first cusps 28, the punch 32 has the opposing sides 34 in the parallel spaced relationship, and the pair of first cusps 28 and second cusp 30 are disposed interiorly to the sides 34. However, it is contemplated that the second cusp 30 may be disposed in any position relative to the cavity 26. In this embodiment of FIGS. 2 through 6, the method includes the step of engaging the outer wall 22 of the manifold 20 with the second cusp 30, as shown in FIG. 2. Also in this embodiment, the step of lancing the outer wall 22 of the manifold 20 is further defined as lancing the outer wall 22 of the manifold 20 utilizing the pair of first cusps 28 and the second cusp 30, as shown in FIGS. 3 through 5. Further, in this embodiment, the step of lancing the outer wall 22 of the manifold 20 includes the step of lancing the outer wall 22 of the manifold 20 utilizing the pair of first cusps 28 and the second cusp 30 prior to the sides 34 engaging the outer wall 22 of the manifold 20. Additionally in this embodiment, the step of moving the first and second cusps 28,30 is further defined as moving the pair of first cusps 28 and the second cusp 30 through the cavity 26 toward the inner tube 24 while maintaining at least one of the pair of first cusps 28 and the second cusp 30 within the cavity 26.

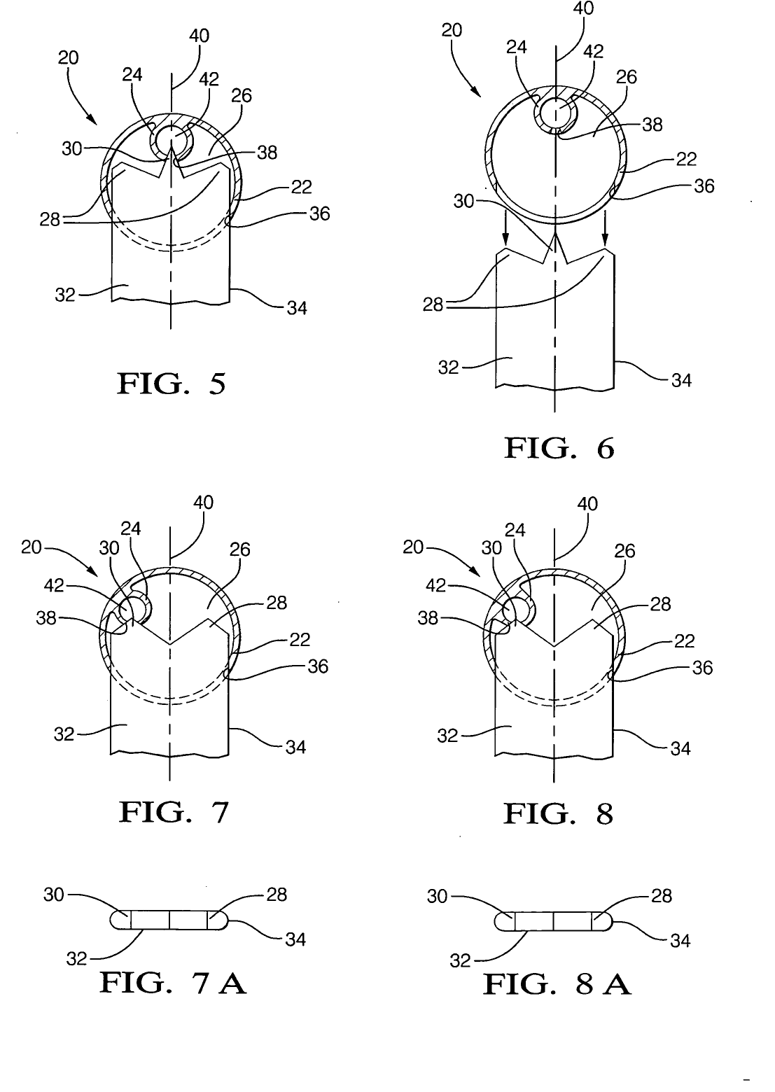

Further, in this embodiment of FIGS. 2 through 6, the method includes the step of aligning the inner tube 24 of the manifold 20 with the second cusp 30 such that the step of aligning is further defined as aligning the inner tube 24 centrally with the punch 32 to align the inner tube 24 with the second cusp 30. However, it is contemplated that the method may include the step of aligning the inner tube 24 of the manifold 20 with the second cusp 30 such that the step of aligning is further defined as aligning the inner tube 24 substantially centered with the punch 32 to align the inner tube 24 with the second cusp 30. Additionally in this embodiment, the step of lancing the inner tube 24 of the manifold 20 is further defined as lancing the inner tube 24 of the manifold 20 utilizing only the second cusp. More specifically in this embodiment, the step of lancing the inner tube 24 of the manifold 20 is further defined as lancing the inner tube 24 of the manifold 20 utilizing only the second cusp 30 with the pair of first cusps 28 flanking the inner tube 24, as shown in FIG. 5. Still further in this embodiment, the step of retracting the punch 32 from the manifold 20 is further defined as retracting the punch 32 through the second aperture 38 in the inner tube 24, through the cavity 26, and through the first aperture 36 in the outer wall 22 of the manifold 20.

Referring now to additional embodiments, such as an embodiment of FIGS. 7 and 8, the punch 30 includes the first cusp 28 and the second cusp 30. In this embodiment, the method includes the step of aligning the inner tube 24 and the second cusp 30. The step of aligning includes the step of rotating the manifold 20.

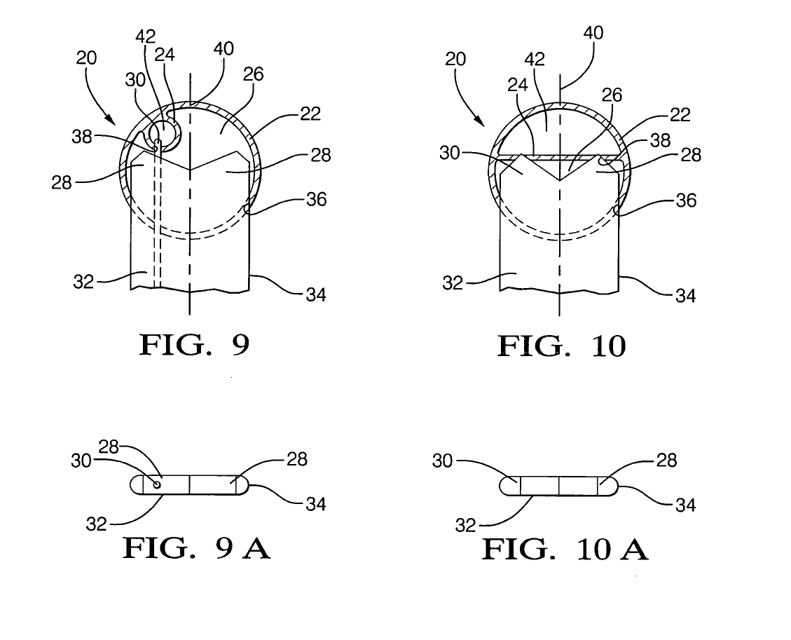

In an embodiment of FIG. 9, the second cusp 30 is offset from the center 40 of the punch 32 adjacent one of the pair of first cusps 28 and the step of lancing the inner tube 24 of the manifold 20 is further defined as lancing the inner tube 24 of the manifold 20 utilizing only the second cusp 30. However, in this embodiment, it is contemplated that the second cusp 30 may be disposed in the center 40 of the punch 32. In this embodiment of FIG. 9, the method also includes the step of aligning the inner tube 24 of the manifold 20 with the second cusp 30, as first introduced above. The step of aligning is further defined as aligning the inner tube 24 offset from the center 40 of the punch 32 to align the inner tube 24 with the second cusp 30. In this embodiment, the second cusp 30 is movable within the punch 32 and the step of lancing the inner tube 24 of the manifold 20 is further defined as moving the second cusp 30 within the punch 32 towards the inner tube 24 and lancing the inner tube 24 utilizing the second cusp 30.

In an embodiment of FIG. 10, the punch 30 includes the first cusp 28 and the second cusp 30. In this embodiment, both the outer wall 22 and the inner tube 24 are lanced utilizing both the first and second cusps 28,30.

In all embodiments, the steps of lancing the outer wall 22 of the manifold 20, moving the first and second cusps 28,30 through the cavity 26, and lancing the inner tube 24 of the manifold 20 are preferably performed by a single continuous movement of the punch 32. These steps are preferably performed in a single movement to reduce production costs and complexities and to reduce manufacturing times of the manifold 20.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, the invention may be practiced otherwise than as specifically described.

What is claimed is:

1. A method of manufacturing a manifold for a heat exchanger with the manifold having an outer wall and an inner tube with a cavity formed between the outer wall and the inner tube and utilizing a punch having a first cusp and a second cusp, said method comprising the steps of:
lancing the outer wall of the manifold utilizing both the first and second cusps to form a first aperture in the outer wall of the manifold and to dispose the first and second cusps in the cavity;
moving the first and second cusps through the cavity toward the inner tube while maintaining at least one of the first and second cusps within the cavity;
lancing the inner tube of the manifold utilizing the second cusp to form a second aperture in the inner tube; and
retracting the punch from the manifold.

2. A method as set forth in claim 1 wherein the steps of lancing the outer wall of the manifold, moving the first and second cusps through the cavity, and lancing the inner tube of the manifold are performed by a single continuous movement of the punch.

3. A method as set forth in claim 1 wherein the step of lancing the inner tube of the manifold is further defined as lancing the inner tube of the manifold utilizing only the second cusp.

4. A method as set forth in claim 1 further comprising the step of aligning the inner tube of the manifold with the second cusp.

5. A method as set forth in claim 4 wherein the step of aligning the inner tube and the second cusp comprises the step of rotating the manifold.

6. A method as set forth in claim 4 wherein the second cusp is disposed in a center of the punch and wherein the step of aligning the inner tube with the second cusp is further defined as aligning the inner tube centrally with the punch to align the inner tube with the second cusp.

7. A method as set forth in claim 4 wherein the second cusp is offset from a center of the punch and wherein the step of aligning the inner tube with the second cusp is further defined as aligning the inner tube offset from the center of the punch to align the inner tube with the second cusp.

8. A method as set forth in claim 1 wherein the step of retracting the punch from the manifold is further defined as retracting the punch through the second aperture in the inner tube, through the cavity, and through the first aperture in the outer wall of the manifold.

9. A method as set forth in claim 1 wherein the punch has a pair of first cusps and the second cusp and wherein the step of lancing the outer wall of the manifold is further defined as lancing the outer wall of the manifold utilizing the pair of first cusps and the second cusp.

10. A method as set forth in claim 9 wherein the second cusp is disposed in a center of the punch between the pair of first cusps and wherein the step of lancing the inner tube of the manifold is further defined as lancing the inner tube of the manifold utilizing only the second cusp with the pair of first cusps flanking the inner tube.

11. A method as set forth in claim 9 wherein the second cusp is offset from a center of the punch adjacent one of the pair of first cusps and wherein the step of lancing the inner tube of the manifold is further defined as lancing the inner tube of the manifold utilizing only the second cusp.

12. A method as set forth in claim 9 wherein the step of moving the first and second cusps is further defined as moving the pair of first cusps and the second cusp through the cavity toward the inner tube while maintaining at least one of the pair of first cusps and the second cusp within the cavity.

13. A method as set forth in claim 1 wherein the punch has opposing sides in a parallel spaced relationship and a pair of first cusps wherein the pair of first cusps and the second cusp are disposed interiorly to the sides and wherein the step of lancing the outer wall of the manifold comprises the step of lancing the outer wall of the manifold utilizing the pair of first cusps and the second cusp prior to the sides engaging the outer wall.

14. A method as set forth in claim 1 wherein the step of lancing the inner tube of the manifold is further defined as moving the second cusp within the punch towards the inner tube and lancing the inner tube utilizing the second cusp.
